(19) United States
(12) Patent Application Publication
(10) Pub. No.: US 2008/0124476 A1
(43) Pub. Date: May 29, 2008

(54) Recording liquid and recording method

(75) Inventor: Katsuya Tanba, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 11/985,969

(22) Filed: Nov. 19, 2007

(30) Foreign Application Priority Data
Nov. 27, 2006 (JP) P2006-318900

(51) Int. Cl. B05D 1/02; C08K 5/00

(52) U.S. Cl. 427/427.4; 524/81

(57) ABSTRACT

A recording liquid containing C.I. Pigment Yellow 128 as a yellow pigment, a water-soluble resin containing at least a (meth)acrylic acid monomer component as a dispersant and a sulfonated isoprene resin is disclosed.

### CROSS REFERENCES TO RELATED APPLICATIONS

The present invention contains subjects related to Japanese Patent Application JP 2006-318900 filed in the Japanese Patent Office on Nov. 27, 2006, the entire contents of which being incorporated herein by reference.

### BACKGROUND OF THE INVENTION

1. Field of the Invention

The present invention relates to a recording liquid containing a yellow pigment and a recording method using this recording liquid.

2. Description of the Related Art

A recording method for performing recording by discharging a recording liquid in a droplet state includes an inkjet recording system for discharging an ink as a recording liquid and recording an image or letters or the like. The inkjet recording system is used in a method in which an ink is discharged in a fine droplet state on a medium to be recorded such as papers, cloths and films from a nozzle of an inkjet head provided in a printer device, thereby recording letters or an image or the like on the medium to be recorded. This inkjet recording system has such advantages that the generation of a noise at the recording is low; that it is easy to cope with colorization; and that a recorded image with a high resolution is obtained at a high speed.

In a printer device of this inkjet recording system, a material obtained by dissolving a water-soluble dye of every kind in water or a mixed solution of water and an organic solvent is used as an ink. However, in the ink using a water-soluble dye, since the water-soluble dye is originally inferior in light fastness, the light fastness of a recoded image or letters is often of a problem. Also, in the case of using a water-soluble dye, since the ink is soluble in water, the water resistance of a printed image or letters is often of a problem. Accordingly, in the ink using a water-soluble dye, in the case where rain, sweat or water for food and drink or the like is applied on a printed image or letters, there is a possibility that the printed image or letters bleed or disappear. Then, in inks, in order to solve the problems of light fastness and water resistance, it is proposed to use a pigment ink in place of the water-soluble dye.

The ink using a pigment contains, in addition to the pigment, a dispersing resin for dispersing this pigment in a solvent such as water. The dispersing resin has a hydrophobic segment to be adsorbed on the pigment and a hydrophilic segment to be dispersed in water. In the ink using a pigment, by adsorbing the dispersing resin having a hydrophilic segment on the pigment, the pigment is dispersed in the solvent.

In a printer device of an inkjet system for discharging an ink by the action of thermal energy, in the case where an ink using a pigment as a coloring material is used, dispersion breaking is caused by heating of a heater for generating thermal energy; the dispersing resin desorbs from the pigment; the pigment and the dispersing resin deposit on a heater surface; and kogation is generated. For that reason, in a printer device where kogation is generated, it is impossible to adequately heat the ink by a heater, whereby discharge stability is lowered.

JP-A-2004-269797 (Patent Document 1) describes that with respect to the matter that when a carboxylic acid in a dispersing resin of a dispersant contained in a pigment ink forms a salt together with calcium or magnesium, dispersion breaking is caused and driving frequency increases, whereby discharge stability is lowered, by using a block copolymer containing a carboxylic acid as a solubilizing group as a dispersant of the pigment, the amount of impurities in the ink, especially the amount of calcium or magnesium for forming a salt together with the carboxylic acid of the dispersing resin is controlled at from 50 ppm to 130 ppm. In the Patent Document 1, by controlling the amount of calcium or magnesium, dispersion breaking is prevented, thereby obtaining discharge stability at a high driving frequency.

Also, in Japanese Patent No. 2899088 (Patent Document 2), for the purpose of reducing a deposit on a heater, by regulating the amount of a high molecular resin to be contained as a dispersant in an ink, the generation of the deposit on the heater is prevented, thereby making it possible to achieve stable discharge.

Now, in a printer device of an inkjet recording system, it is desirable that the printing speed is further increased, and for the purpose of shortening the discharge interval of an ink, the driving frequency of a heater is increased. For that reason, a pigment ink to be used in such a printer device is required to have discharge stability such that it can be stably discharged even at a high driving frequency.

Also, in a printer device for printing a color image or letters by using inks such as a yellow ink, a magenta ink and a cyan ink, from the foregoing viewpoints of light fastness and water resistance, pigment based inks are being used. For example, when the yellow ink is concerned, C.I. Pigment Yellow 128 which is excellent in the light fastness is frequently used as the pigment.

However, among pigments to be used in the inks, pigments used in the magenta ink, cyan ink and black ink easily adsorb a dispersant, and the dispersant hardly desorbs due to heat of a heater. Therefore, in such pigments, kogation is not generated, and the discharge stability is good. However, C.I. Pigment Yellow 128 as a yellow pigment has a characteristic that the dispersant easily desorbs. For that reason, in a yellow ink using C.I. Pigment Yellow 128, the desorbed dispersant or C.I. Pigment Yellow 128 as the pigment deposits on the heater; kogation is easily generated; the discharge stability at a driving frequency, especially a high driving frequency is poor; and continuous discharge properties in a high-speed printer device are poor. That is, since the yellow ink containing C.I. Pigment Yellow 128 is poor in the discharge stability at a high driving frequency, it is unsuitable for high-speed recording.

### SUMMARY OF THE INVENTION

It is desirable to provide a recording liquid using C.I. Pigment Yellow 128 as a pigment, which, even when a driving frequency is increased, has a stable discharge characteristic, and a recording method using the same.

A recording liquid according to an embodiment of the present invention contains C.I. Pigment Yellow 128 as a yellow pigment, a water-soluble resin containing at least a (meth)acrylic acid monomer component as a dispersant and a sulfonated isoprene resin.

Also, a recording method according to an embodiment of the present invention is a method including the steps of pressurizing a recording liquid by a pressure-generating element; and discharging the pressurized recording liquid from a discharge opening to impact the recording liquid on a medium to be recorded, the recording liquid containing C.I. Pigment Yellow 128 as a yellow pigment, a water-soluble resin containing at least a (meth)acrylic acid monomer component as a dispersant and a sulfonated isoprene resin.

According to the embodiments of the present invention, a recording liquid which is able to prevent the generation of kogation caused due to the deposition of a pigment or a dispersant on a heat-generating resistor and which, even when a driving frequency is high, is able to achieve stable discharge because it contains C.I. Pigment Yellow 128, a water-soluble resin containing at least a (meth)acrylic acid monomer component as a dispersant and a sulfonated isoprene resin and a recording method using the same are provided.

### BRIEF DESCRIPTION OF THE DRAWINGS

FIG. 1 is an exploded perspective view of a printer device to which an embodiment according to the present invention is applied.

FIG. 2 is an exploded perspective view of a head cartridge.

FIG. 3 is a cross-sectional view of the same head cartridge.

FIGS. 4A and 4B each shows an ink discharge head, in which FIG. 4A is a cross-sectional view schematically showing a state that an air bubble is generated on a heat-generating resistor, and FIG. 4B is a cross-sectional view schematically showing a state that an ink is discharged from a nozzle.

FIG. 5 is a perspective side view for explaining a printing operation of the same printer device.

### DETAILED DESCRIPTION OF THE PREFERRED EMBODIMENTS

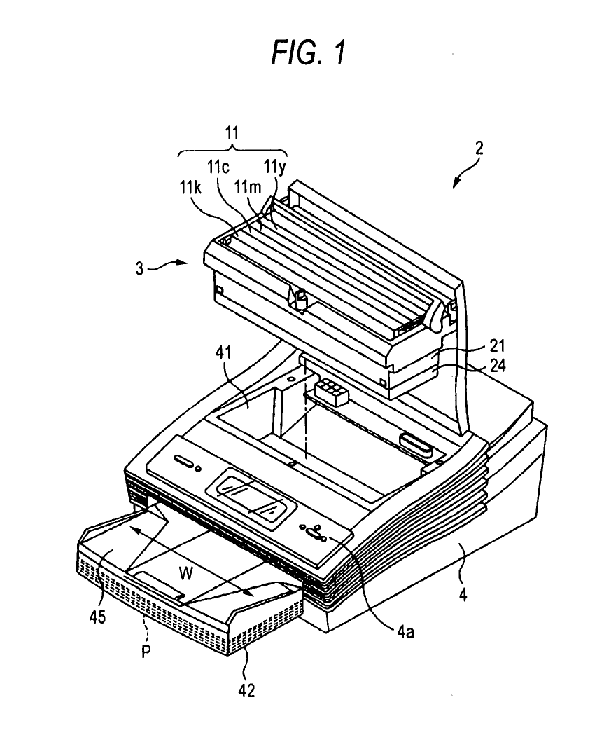

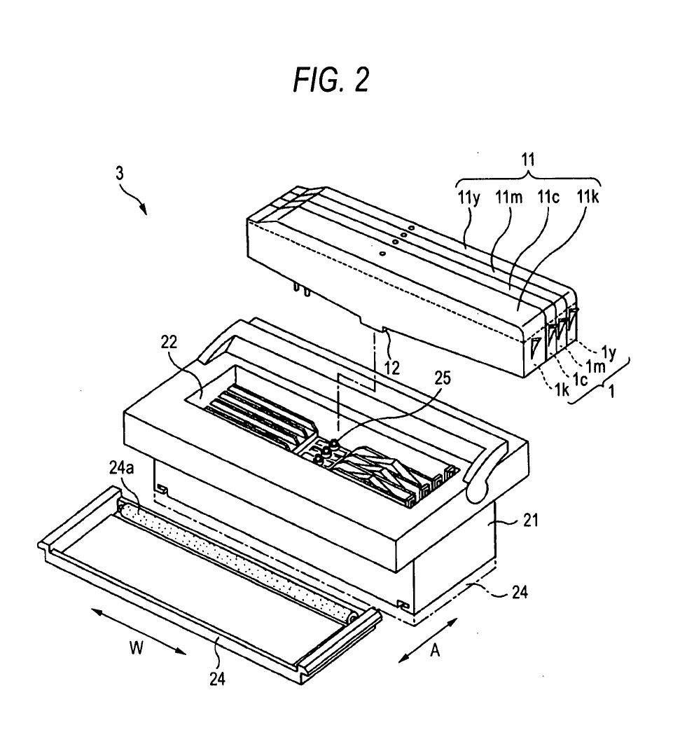

A yellow ink to which an embodiment according to the present invention is applied is hereunder described. A yellow ink 1y to which an embodiment according to the present invention is applied is used in an inkjet printer device (hereinafter referred to as “printer device”) 2 as illustrated in FIG. 1. As illustrated in FIG. 2, the yellow ink 1y is used together with other magenta ink 1m, cyan ink 1c and black ink 1k in the printer device 2, thereby forming a color image or letters. The yellow ink 1y, magenta ink 1m, cyan ink 1c and black ink 1k may be hereunder referred to as “ink 1” collectively and simply. Prior to the description of the yellow ink 1y to which an embodiment of the present invention is applied, first of all, the printer device 2 of a line type in which this yellow ink 1y is used is described.

As illustrated in FIG. 1, the printer device 2 is provided with an inkjet printer head cartridge (hereinafter referred to as “head cartridge”) 3 for discharging the foregoing inks onto, for example, recording paper P which is an object and a device main body 4 in which this head cartridge 3 is installed. This printer device 2 is a so-called line type printer device in which nozzles for discharging an ink in a width direction of the recording paper P, namely in an arrow W direction in FIG. 1 are juxtaposed in one or more rows in a substantially line state. In this printer device 2, the head cartridge 3 is detachable to the device main body 4.

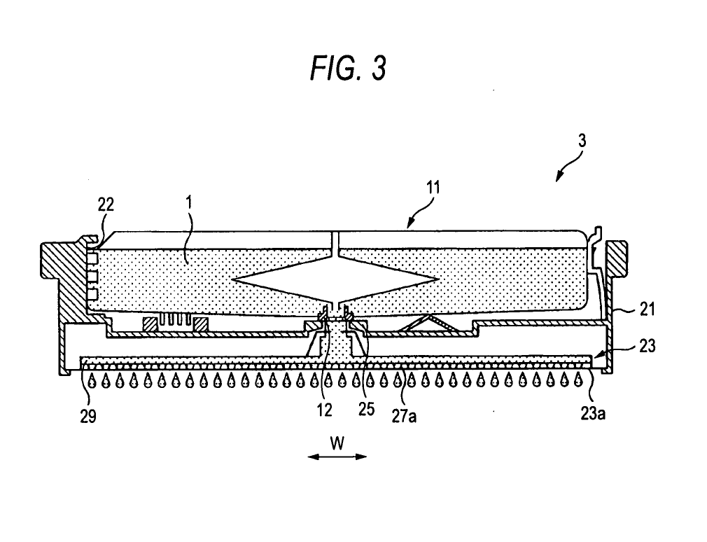

First of all, the head cartridge 3 configuring the printer device 2 is described. The head cartridge 3 discharges the ink 1 by, for example, a heat-generating resistor employing an electro-thermal conversion type as a pressure-generating element and impacts the ink 1 on a principal face of the recording paper P. As illustrated in FIGS. 2 and 3, an ink cartridge 11 having the ink 1 accommodated therein is installed in the head cartridge 3. The ink cartridge 11 is provided with an ink cartridge 11y of the yellow ink 1y, an ink cartridge 11m of the magenta ink 1m, an ink cartridge 11c of the cyan ink 1c and an ink cartridge 11k of the black ink 1k for every color. The ink cartridge 11 is formed in a substantially rectangular shape having substantially the same size as the size in the width direction of the recording paper P. As illustrated in FIGS. 2 and 3, the ink cartridge 11 is provided with an ink feed part 12 for feeding the ink 1 into a cartridge main body 21 of the head cartridge 3.

The ink feed part 12 is provided in a substantially central part of the bottom face. This ink feed part 12 is a nozzle having a substantially projected shape, and when a tip of this nozzle is interfitted in a connection part 25 of the head cartridge 3 as described later, the ink cartridge 11 and the cartridge main body 21 of the head cartridge 3 are connected to each other such that the ink can be fed. The ink feed part 12 is provided with a valve mechanism, and the feed of the ink 1 into the cartridge main body 21 is adjusted by this valve mechanism. The ink cartridge 11 may be integrally formed with the head cartridge 3.

As illustrated in FIGS. 2 and 3, the head cartridge 3 in which the ink cartridge 11 is installed has the cartridge main body 21. The cartridge main body 21 is provided with an installation part 22 in which the ink cartridge 11 is installed, an ink discharge head 23 for discharging the ink 1 and a head cap 24 for protecting the ink discharge head 23.

The connection part 25 which is connected to the ink feed part 12 of the ink cartridge 11 installed in the installation part 22 is provided in substantially the center in a longitudinal direction of the installation part 22. This connection part 25 makes an ink feed passage for feeding the ink 1 from the ink feed part 12 of the ink cartridge 11 installed in the installation part 22 into the ink discharge head 23 for discharging the ink 1 as provided on the bottom face of the cartridge main body 21. In the connection part 25, the feed of the ink 1 from the ink cartridge 11 into the ink discharge head 23 is adjusted by a valve mechanism.

The ink discharge head 23 into which the ink 1 is fed from the connection part 25 is arranged along the bottom face of the cartridge main body 21. In the ink discharge head 23, nozzles 27a as described later, each of which is a discharge opening for discharging the ink 1 fed from the connection part 25, are juxtaposed in a substantially line state for every color in the width direction of the recording paper P, namely in the arrow W direction in FIG. 3. In discharging the ink 1, the ink discharge head 23 discharges the ink 1 in every nozzle line of a yellow nozzle line, a magenta nozzle line, a cyan nozzle line and a black nozzle line in order without being moved in the width direction of the recording paper P.

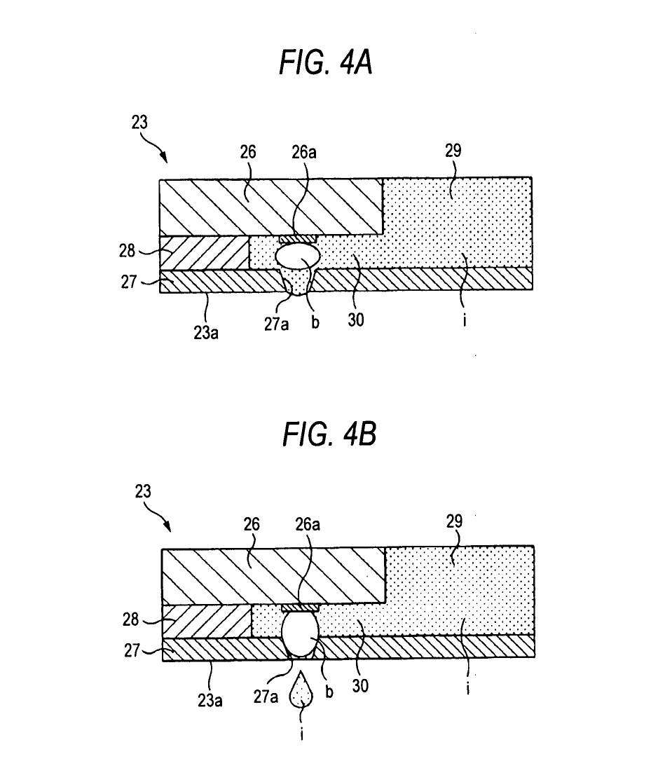

As illustrated in FIGS. 4A and 4B, in the ink discharge head 23, a circuit board 26 provided with a heat-generating resistor 26a of an electro-thermal conversion type and a nozzle 27a are formed; and an ink passage 29 for feeding the ink 1 fed from the connection part 25 into each nozzle 27a is formed by a nozzle sheet 27 formed of a metal thin film such as nickel plating and a film 28 provided between the circuit board 26 and the nozzle sheet 27. This ink passage 29 is formed long in the direction at which the nozzles 27a are juxtaposed, namely in the arrow W direction in FIG. 3. According to this, in the ink discharge head 23, the ink 1 flows from the ink cartridge 11 into the ink passage 29 via the connection part 25 of the head cartridge 3, and the ink 1 is fed from the ink passage 29 into each of the nozzles 27a.

In the ink discharge head 23, an ink liquid compartment 30 which is surrounded by the circuit board 26, the nozzle sheet 27 and the film 28 and in which the heat-generating resistor 26a pressurizes the ink 1 is formed.

In the ink discharge head 23 having the foregoing configuration, a pulse current is fed into the heat-generating resistor 26a selected on a basis of printing data for a period of time of, for example, from about 1 to 3 microseconds. According to this, in the ink discharge head 23, the heat-generating resistor 26a is driven and rapidly heated. In the ink discharge head 23, when the heat-generating resistor 26a is heated, as illustrated in FIG. 4A, an air bubble b is formed in the ink 1 coming into contact with the heat-generating resistor 26a. Then, in the ink discharge head 23, as illustrated in FIG. 4B, the air bubble b pressurizes the ink 1 while being expanded, and the ink 1 thus pushed away becomes in a droplet state and is discharged from the nozzle 27a. After discharging the droplet of the ink 1, the ink discharge head 23 is again returned to an original state before discharging by feeding the ink 1 from the ink cartridge 11 into the ink liquid compartment 30 through the ink passage 29 via the connection part 25. The ink discharge head 23 repeats the foregoing operations on a basis of printing data and discharges the ink 1 onto the recording paper P.

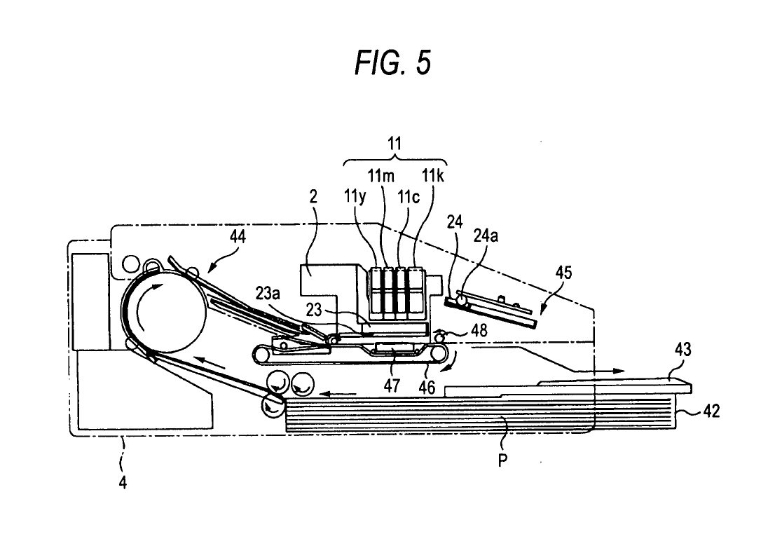

As illustrated in FIG. 2, during a period of time when the ink 1 is not discharged and printing is not performed, the head cap 24 for protecting a discharge face 23a of the ink discharge head 23 closes the discharge face 23a of the ink discharge head 23, thereby protecting the nozzle 27a from drying or the like. As illustrated in FIGS. 2 and 5, in performing printing, the head cap 24 moves from the bottom face of the head cartridge 3 into a front face side of the device main body 4 and exposes the discharge face 23a of the ink discharge head 23 to the outside. This head cap 24 is provided with a cleaning roller 24a for wiping out the excess of the ink 1 attached to the discharge face 23a. In the head cap 24, in leaving the discharge face 23a open, the discharge face 23a is cleaned up by the cleaning roller 24a.

As illustrated in FIG. 1, in the device main body 4 in which the head cartridge 3 is installed, the head cartridge 3 is installed in a head cartridge installation part 41. The device main body 4 is mounted with a paper feed tray 42 in which the recording papers P prior to printing are stacked and accommodated in a lower side of the front face thereof and mounted with a paper discharge tray 43 for accommodating the recording papers P after printing in an upper side of the front face thereof.

As illustrated in FIG. 5, the device main body 4 is provided with a paper feed and discharge mechanism 44 for conveying the recording paper P and a head cap opening and closing mechanism 45 for opening and closing the head cap 24.

According to the foregoing configuration, in the printer device 2, the paper feed and discharge of the recording paper P, the opening and closing of the head cap 24 and the feed of a current into the ink discharge head 23 are controlled by a control part provided in a control circuit for controlling the feed of a current to be fed into the paper feed and discharge mechanism 44, the head cap opening and closing mechanism 45 and the ink discharge head 23 on a basis of printing data inputted from an externally provided information processor.

Concretely, in the printer device 2, first of all, when the control part is ordered to start printing by the operation of an operation button 4a provided in the device main body 4, the paper feed and discharge mechanism 44 and the head cap opening and closing mechanism 45 are driven by a control signal from the control part, whereby the printer device 2 becomes in a state that printing is possible as illustrated in FIG. 5.

In the printer device 2, the head cap 24 is moved into the front face side of the device main body 4 provided with the paper feed tray 42 and the paper discharge tray 43 relative to the head cartridge 3 by the head cap opening and closing mechanism 45. According to this, in the printer device 2, each of the nozzles 27a provided on the discharge face 23a of the ink discharge head 23 is exposed to the outside, whereby it is able to discharge the ink 1.

In the printer device 2, only one sheet of the recording paper P is drawn out from the paper feed dray 42 by the paper feed and discharge mechanism 44. Then, in the printer device 2, the recording paper P is conveyed onto a conveyance belt 46 provided in a position opposing to the discharge face 23a of the ink discharge head 23 by the paper feed and discharge mechanism 44. In the printer device 2, by supporting the recording paper P conveyed onto the conveyance belt 46 in a prescribed position by a platen plate 47, the recording paper P is made opposite to the discharge face 23a.

Next, in the printer device 2, a driving current is fed into the heat-generating resistor 26a selected among the plural heat-generating resistors 26a provided in the ink discharge head 23 on a basis of a control signal of printing data, thereby heating the selected heat-generating resistor 26a. In the printer device 2, as illustrated in FIGS. 4A and 4B, the ink 1 is discharged in a droplet state onto the conveyed recording paper P in a position opposing to the discharge face 23a from each of the nozzles 27a by heating the heat-generating resistors 26a, there by printing an image or letters or the like.

Next, in the printer device 2, the recording paper P in which printing of an image or letters or the like has been finished is sent out by the conveyance belt 46 rotating in a direction of the paper discharge tray 43 and a paper discharge roller 48 opposing to the conveyance belt 46 and provided in a side of the paper discharge tray 43 relative to the discharge face 23a, whereby the recording paper P after printing is discharged into the paper discharge tray 43. In the printer device 2, printing is carried out on the recording paper P in this manner. After printing, by moving the head cap 24 standing by in the front face side of the device main body 4 into the bottom face of the head cartridge 3 by the head cap opening and closing mechanism 45, the discharge face 23a of the ink discharge head 23 is clogged and protected. On that occasion, the discharge face 23a may be cleaned up by the cleaning roller 24a.

In the printer device 2 having the foregoing configuration, since the ink 1 is discharged for every nozzle line of each color, the number of the nozzles 27a from which the ink 1 of each color is discharged at once is high, and printing is performed at a high speed. Thus, the driving frequency of each of the heat-generating resistors 26a is high. In the printer device 2, a yellow ink 1y using a yellow pigment which is classified into C.I. Pigment Yellow 128 in terms of a color index (hereinafter referred to as “C.I. Pigment Yellow 128”) is used as the yellow ink 1y. As described below, owing to the matters that a water-soluble resin containing at least a (meth)acrylic acid monomer component is contained as a dispersant and that a sulfonated isoprene resin is further contained, desorption of the water-soluble resin as a dispersant from C.I. Pigment Yellow 128 is prevented; C.I. Pigment Yellow 128 and the water-soluble resin do not deposit on the heat-generating resistor 26a; and kogation is prevented. In this printer device 2, kogation is prevented, whereby even at a high driving frequency, the yellow ink can be adequately discharged, and printing can be achieved.

Then, next, the yellow ink 1y to be used in the printer device 2 is described. The yellow ink 1y uses C.I. Pigment Yellow 128 as a pigment, contains a water-soluble resin containing at least a (meth)acrylic acid monomer component as a dispersant for dispersing this pigment and further containing a sulfonated isoprene resin. In the yellow ink 1y, C.I. Pigment Yellow 128, the water-soluble resin and the sulfonated isoprene resin are dispersed or dissolved in an aqueous medium.

In this yellow ink 1y, even when C.I. Pigment Yellow 128 is used as the pigment, owing to the matter that the sulfonated isoprene resin is contained, desorption of the water-soluble resin containing a (meth)acrylic acid monomer component as a dispersant from C.I. Pigment Yellow 128 is prevented; deposition of C.I. Pigment Yellow 128 and the water-soluble resin on the heat-generating resistor 26a can be prevented; and kogation can be prevented. Also, in this yellow ink 1y, owing to the matter that the sulfonated isoprene resin is contained, fixability of the pigment to the recording paper P is good.

The water-soluble resin as a dispersant which is contained in the yellow ink 1y contains at least an acrylic acid component or a methacrylic acid component as the (meth)acrylic acid monomer component. Specific examples of the acrylic acid component or methacrylic acid component include polyacrylic acid, polymethacrylic acid, (meth)acrylic acid-(meth)acrylic alkyl ester copolymers, (meth)acrylic acid-maleic half ester copolymers, (meth)acrylic acid-maleic dialkyl ester copolymers, styrene-(meth)acrylic acid copolymers and styrene-(meth)acrylic acid-(meth)acrylic alkyl ester copolymers.

Such an acrylic acid component or methacrylic acid component can be modified with a synthetic resin such as alkyd resins, epoxy resins, melamine resins, polyesters, polyvinyl alcohol and polyethers; or a natural resin such as rosin resins as the need arises. The water-soluble resin is one obtained by neutralizing such an acrylic acid component or methacrylic acid component with a volatile basic compound selected from ammonia, an amine, an alkanolamine and an alkyl alkanolamine or a metal hydroxide such as sodium hydroxide and potassium hydroxide, thereby making it dispersible or soluble in an aqueous medium.

This water-soluble resin is a (meth)acrylic acid based resin containing a (meth)acrylic acid monomer as a component and having a weight average molecular weight of not more than 20,000, and preferably from about 1,000 to 10,000 and an acid value in the range of from 100 to 250, and preferably from 150 to 250; and it is especially preferable that the water-soluble resin is soluble in an alkaline aqueous solution.

In this water-soluble resin, owing to the matter that the weight average molecular weight is not more than 20,000, the viscosity of the yellow ink 1y does not become too high, and good discharge stability is obtained. Also, in this water-soluble resin, owing to the matter that the acid value is 100 or more, redissolution properties are obtained; and owing to the matter that the acid value is not more than 250, the solubility in water does not become too high, a lowering in the marker resistance or water resistance of a recorded material can be prevented.

Among these water-soluble resins, commercially available products can be used as the acrylic resin based resin. Examples thereof include JONCRYL 57 (molecular weight: 4, 900, acid value: 215), JONCRYL 61J (molecular weight: 12,000, acid value: 195), JONCRYL 68 (molecular weight: 10,000, acid value: 195), JONCRYL 550 (molecular weight: 7,500, acid value: 200), JONCRYL 555 (molecular weight: 5,000, acid value: 200), JONCRYL 586 (molecular weight: 3,100, acid value: 105), JONCRYL 680 (molecular weight: 3,900, acid value: 215), JONCRYL 682 (molecular weight: 1,600, acid value: 235) and JONCRYL 683 (molecular weight: 7,300, acid value: 150), all of which are manufactured by Johnson Polymer, Inc.

It is preferable that this acrylic acid based resin is added such that its content is from 0.1% by weight to 10% by weight, and preferably from 0.5% by weight to 5% by weight relative to the total weight of the yellow ink 1k and from about 10% by weight to 100% by weight relative to the pigment, respectively.

The sulfonated isoprene resin which is contained in the yellow ink makes the fixability of the pigment to the recording paper P good.

The sulfonated isoprene resin is preferably one obtained by neutralization with an alkali, and examples thereof include ones obtained by neutralization with an alkali metal (for example, Na, Li and K) or an organic ammonium. Examples of the organic ammonium include methylammonium, dimethylammonium, trimethylammonium, ethylammonium, diethylammonium, triethylammonium, trihydroxymethylamine, dihydroxymethyl-amine, monohydroxymethylamine, monoethanolammonium, di-ethanolammonium, triethanolammonium, N-methylmonoethanol-ammonium, N-methyldiethanolammonium, monopropanolammonium, dipropanolammonium and tripropanolammonium. These organic ammoniums are each derived from a corresponding organic amine.

The content of the sulfonated isoprene resin is from 0.1% by weight to 6% by weight relative to the total weight of the yellow ink 1y. By regulating the content of the sulfonated isoprene resin at 0.1% by weight or more, the fixability of the yellow ink 1y to the recording paper P is made good, and the feed of the yellow ink 1y from the ink cartridge 11y into the ink liquid compartment 30 of the ink discharge head 23 becomes good. Also, by regulating the content of the sulfonated isoprene resin at not more than 6% by weight, the generation of kogation can be prevented without being deposited on the heat-generating resistor 26a. Of the range of from 0.1% by weight to 6% by weight regarding the content of the sulfonated isoprene resin, a range of from 1% by weight to 4% by weight is preferable.

As a solvent for dissolving or dispersing the foregoing pigment, water-soluble resin and sulfonated isoprene resin therein, ion exchanged water, a water-soluble organic solvent and the like are useful.

Examples of the water-soluble organic solvent include polyhydric alcohols such as ethylene glycol, diethylene glycol, propylene glycol, butylenes glycol, triethylene glycol, 1,5-pentanediol, 1,2,6-hexanetriol, trimethylolpropane and glycerin; polyhydric alcohol derivatives such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether and dipropylene glycol monobutyl ether; nitrogen-containing solvents such as 2-pyrrolidone, N-methyl-2-pyrrolidone, cyclohexylpyrrolidone and triethanolamine; and sulfur-containing solvents such as thiodiethanol, thioglycerol, sulforane and dimethyl sulfoxide. Above all, it is preferable that the water-soluble organic solvent contains at least one member selected from the group consisting of glycerin, 2-pyrrolidone and glycols having from 3 to 6 carbon atoms. These water-soluble organic solvents may be used singly or in admixture of two or more kinds thereof.

The content of this water-soluble organic solvent is preferably from 1% by weight to 60% by weight, and more preferably from 5% by weight to 40% by weight relative to the total weight of the yellow ink 1y.

Since the yellow ink 1y having the foregoing constitution is used in the printer device 2 of the foregoing inkjet recording system, the yellow ink 1y may be required to have such a characteristic that it can be discharged from the nozzle 27a of the ink discharge head 23. From the viewpoint of discharge properties from the ink discharge head 24, with respect to the characteristic of the yellow ink 1y, for example, it is preferable that the yellow ink 1y has a viscosity of from 1 to 15 cPs and a surface tension of 25 dyn/cm or more. In particular, it is more preferable that the yellow ink 1y has a viscosity of from 1 to 5 cPS and a surface tension of from 25 to 50 dyn/cm.

Furthermore, in the yellow ink 1y, for the purpose of forming an ink having desired physical properties, a surfactant, an anti-foaming agent, an antiseptic, an antifungal agent, a pH modifier, an antioxidant and the like may be added as the need arises.

Owing to the matter that the foregoing yellow ink 1y contains C.I. Pigment Yellow 128, a water-soluble resin containing at least a (meth)acrylic acid monomer component as a dispersant and a sulfonated isoprene resin, the desorption of the water-soluble resin as a dispersant from C.I. Pigment Yellow 128 can be prevented. According to this, in this yellow ink 1y, C.I. Pigment Yellow 128 or the water-soluble resin as a dispersant does not deposit on the heat-generating resistor 26a of the ink discharge head 23, and the generation of kogation can be prevented. Also, owing to the matter that the yellow ink 1y contains the sulfonated isoprene resin, it is easily fed from the ink cartridge 11y into the ink liquid compartment 30 via the ink passage 29 of the ink discharge head 23, and the generation of a fault such as non-discharge can be prevented.

The foregoing printer device 2 is of a line type in which the nozzles 27a are provided for every color over the width direction of the recording paper P, and printing is performed at a high speed. Thus, the driving frequency of each of the heat-generating resistors 26a is high. However, the generation of kodation due to the yellow ink 1y is prevented, and the feed of the yellow ink 1y into the ink liquid compartment 30 is good. Accordingly, the yellow ink 1y can be discharged stably and continuously.

Also, since the yellow ink 1y contains the sulfonated isoprene resin, its fixability to the recording paper P is good, C.I. Pigment Yellow 128 does not desorb from the recording paper P, and the generation of a blur in an image or letters can be prevented.

Also, owing to the matter that the yellow ink 1y uses C.I. Pigment Yellow 128 as a pigment, it is excellent in the light fastness of an image or letters as compared with the case of using other yellow pigment.

Each of other magenta ink 1m, cyan ink 1c and black ink 1k than the foregoing yellow ink 1y has the same constitution as in an ink of each color which has hitherto been known. With respect to the pigment, dispersant and organic solvent, those which have hitherto been used in an ink of each color can be used.

Owing to the matter that the foregoing yellow ink 1y contains C.I. Pigment Yellow 128, a water-soluble resin containing at least a (meth)acrylic acid monomer component as a dispersant and a sulfonated isoprene resin, even when the driving frequency of the heat-generating resistor 26a is high, the yellow ink 1y has discharge stability equal to that in the magenta ink 1m, cyan ink 1c and black ink 1k.

The use of the yellow ink 1y is not limited to the foregoing line type printer device 2. The yellow ink 1y can also be used in a serial type printer device for carrying out printing of one line by moving the ink discharge head 23 in the width direction of the recording paper P. The yellow ink 1y is excellent in the driving frequency characteristic, is stably discharged and has good fixability to the recording paper P.

Also, the yellow ink 1y can be applied to not only an electro-thermal conversion system for discharging it in a droplet state from the nozzle 27a upon being heated by the heat-generating resistor 26a as in the foregoing printer device 2 but a recording system, for example, a piezoelectric system for flying fine droplets by utilizing vibration of a piezoelectric element, whereby an image or letters with good fixability can be formed.

### EXAMPLES

Examples and Comparative Examples in which a yellow ink to which an embodiment of the present invention was applied was prepared are hereunder described. First of all, dispersions of a yellow ink as described below were prepared, and yellow inks of the Examples and Comparative Examples were prepared by using these dispersions.

### (Dispersion 1)

Dispersion 1 was prepared by mixing 15% by weight of a trade name, 8G-CF (C.I. Pigment Yellow 128, manufactured by Ciba Speciality Chemicals) as a pigment, 8.1% by weight of a trade name, JONCRYL 57 (manufactured by Johnson Polymer, Inc.) as a dispersant and 76.9% by weight of ion exchanged water, dispersing the mixture by a paint shaker (medium: zirconia having a size of 1 mm, packing rate of medium: 70%) and removing coarse particles by a centrifuge.

### (Dispersion 2)

Dispersion 2 was prepared by mixing 15% by weight of a trade name, 8G-CF (C.I. Pigment Yellow 128, manufactured by Ciba Speciality Chemicals) as a pigment, 10% by weight of a trade name, JONCRYL 61J (manufactured by Johnson Polymer, Inc.) as a dispersant and 75% by weight of ion exchanged water, dispersing the mixture by a paint shaker (medium: zirconia having a size of 1 mm, packing rate of medium: 70%) and removing coarse particles by a centrifuge.

Inks of the Examples and Comparative Examples were prepared by using each of the thus prepared Dispersion 1 and Dispersion 2.

### Example 1

In Example 1, a yellow ink was prepared in the following manner. That is, 26.7% by weight of Dispersion 1, 15% by weight of 1,5-pentanediol as a water-soluble organic solvent, 40% byweightof DYNAFLOW K201 (manufactured by JSR Corporation, solids content: 15% by weight) as a sulfonated isoprene resin and 18.3% by weight of ion exchanged water were mixed and thoroughly stirred, and the resulting mixture was filtered by using a filter to prepare a yellow ink. Since 40% by weight of DYNAFLOW K201 having a solids content of 15% by weight is contained in the yellow ink, the sulfonated isoprene resin should be contained in an amount of 6% by weight.

### Example 2

In Example 2, a yellow ink was prepared in the following manner. That is, 26.7% by weight of Dispersion 1, 15% by weight of 1,5-pentanediol as a water-soluble organic solvent, 13.3% by weight of DYNAFLOW K201 (manufactured by JSR Corporation, solids content: 15% by weight) as a sulfonated isoprene resin and 45% by weight of ion exchanged water were mixed and thoroughly stirred, and the resulting mixture was filtered by using a filter to prepare a yellow ink. Since 13.3% by weight of DYNAFLOW K201 having a solids content of 15% by weight is contained in the yellow ink, the sulfonated isoprene resin should be contained in an amount of 2% by weight.

### Example 3

In Example 3, a yellow ink was prepared in the following manner. That is, 26.7% by weight of Dispersion 1, 15% by weight of propylene glycol as a water-soluble organic solvent, 0.67% by weight of DYNAFLOW K202 (manufactured by JSR Corporation, solids content: 15% by weight) as a sulfonated isoprene resin and 57.63% by weight of ion exchanged water were mixed and thoroughly stirred, and the resulting mixture was filtered by using a filter to prepare a yellow ink. Since 0.67% by weight of DYNAFLOW K202 having a solids content of 15% by weight is contained in the yellow ink, the sulfonated isoprene resin should be contained in an amount of 0.1% by weight.

### Example 4

In Example 4, a yellow ink was prepared in the following manner. That is, 26.67% by weight of Dispersion 2, 15% by weight of propylene glycol as a water-soluble organic solvent, 26.7% by weight of DYNAFLOW K202 (manufactured by JSR Corporation, solids content: 15% by weight) as a sulfonated isoprene resin and 31.63% by weight of ion exchanged water were mixed and thoroughly stirred, and the resulting mixture was filtered by using a filter to prepare a yellow ink. Since 26.7% by weight of DYNAFLOW K202 having a solids content of 15% by weight is contained in the yellow ink, the sulfonated isoprene resin should be contained in an amount of 4% by weight.

### Example 5

In Example 5, a yellow ink was prepared in the following manner. That is, 26.67% by weight of Dispersion 2, 15% by weight of propylene glycol as a water-soluble organic solvent, 6.67% by weight of DYNAFLOW K202 (manufactured by JSR Corporation, solids content: 15% by weight) as a sulfonated isoprene resin and 51.66% by weight of ion exchanged water were mixed and thoroughly stirred, and the resulting mixture was filtered by using a filter to prepare a yellow ink. Since 6.67% by weight of DYNAFLOW K202 having a solids content of 15% by weight is contained in the yellow ink, the sulfonated isoprene resin should be contained in an amount of 1% by weight.

### Comparative Example 1

In Comparative Example 1, a yellow ink was prepared in the following manner. That is, 26.7% by weight of Dispersion 1, 15% by weight of 1,5-pentanediol as a water-soluble organic solvent and 58.3% by weight of ion exchanged water were mixed and thoroughly stirred, and the resulting mixture was filtered by using a filter to prepare a yellow ink.

### Comparative Example 2

In Comparative Example 2, a yellow ink was prepared in the following manner. That is, 26.7% by weight of Dispersion 2, 15% by weight of propylene glycol as a water-soluble organic solvent and 58.3% by weight of ion exchanged water were mixed and thoroughly stirred, and the resulting mixture was filtered by using a filter to prepare a yellow ink.

### Comparative Example 3

In Comparative Example 3, a yellow ink was prepared in the following manner. That is, 26.7% by weight of Dispersion 2, 15% by weight of propylene glycol as a water-soluble organic solvent, 53.3% by weight of DYNAFLOW K202 (manufactured by JSR Corporation, solids content: 15% by weight) as a sulfonated isoprene resin and 5% by weight of ion exchanged water were mixed and thoroughly stirred, and the resulting mixture was filtered by using a filter to prepare a yellow ink. Since 53.3% by weight of DYNAFLOW K202 having a solids content of 15% by weight is contained in the yellow ink, the sulfonated isoprene resin should be contained in an amount of 8% by weight.

With respect to the thus prepared yellow inks of Examples 1 to 5 and Comparative Examples 1 to 3, a printing test with a varied driving frequency of a heat-generating resistor was carried out.

The printing test was carried out in the following manner. That is, a head cartridge in which an ink discharge head and an ink cartridge were integrated was removed from a main body of a printer device of the foregoing line type (having a line head of an A4 size width and a resolution of 600 dpi), and the yellow ink of each of the Examples and Comparative Examples was filled in the ink cartridge. Then, with respect to the respective yellow inks, a printing pattern in which the driving frequency of the heat-generating resistor of the ink discharge head was 1.9 kHz and 9.6 kHz, respectively was solid printed, and at that time, the state of unevenness in printing was visually evaluated.

Results of the printing test are shown in the following Table 1.

TABLE 1

Results of printing test

| | 1.9 kHz | 9.6 kHz |
|---|---|---|
| Example 1 | B | B |
| Example 2 | A | A |
| Example 3 | A | B |
| Example 4 | A | A |
| Example 5 | A | A |
| Comparative Example 1 | B | C |
| Comparative Example 2 | B | C |
| Comparative Example 3 | C | C |

In Table 1, the case where the ink is free from non-discharge and does not generate unevenness in density is designated as “A”; the case where the ink partially generates unevenness in density and a blur as compared with the state that unevenness in density is not generated (the case of “A”) is designated as “B”; and the case where the ink is not discharged and cannot achieve printing is designated as “C”.

As is clear from Table 1, in Examples 1 to 5, good results of the printing test were brought as compared with Comparative Examples 1 to 3.

In Comparative Examples 1 and 2, since the sulfonated isoprene resin is not contained in the yellow ink, the yellow ink is hardly filled from the ink cartridge into the ink liquid compartment of the ink discharge head, and in particular, when the driving frequency of the heat-generating resistor is high, the yellow ink is more hardly filled. Accordingly, when the driving frequency was low as 1.9 kHz, unevenness in printing or a blur was generated. On the other hand, when the driving frequency was high as 9.6 kHz, the ink was not discharged; printing could not be achieved; and the frequency characteristic became worse with an increase of the driving frequency.

In Comparative Example 3, since the sulfonated isoprene resin is contained in an amount of 6% by weight or more in the yellow ink, the content of the sulfonated isoprene resin is too high. Accordingly, the sulfonated isoprene resin deposited on the heat-generating resistor; even when the driving frequency was low, the ink could not be discharged; and the frequency characteristic became worse.

In contrast to these Comparative Examples, in Examples 1 to 5, since the sulfonated isoprene resin was contained in an amount in the range of from 0.1% by weight to 6% by weight, the yellow ink was well fed from the ink cartridge into the ink liquid compartment of the ink discharge head, and even when the driving frequency of the heat-generating resistor was high, the feed of the yellow ink into the ink liquid compartment was good. Also, in Examples 1 to 5, since the sulfonated isoprene resin was contained in an amount in the range of from 0.1% by weight to 6% by weight, the water-soluble resin as a dispersant did not desorb from C.I. Pigment Yellow 128 as a pigment; the pigment or water-soluble resin did not deposit on the heat-generating resistor; and kogation could be prevented. Owing to these matters, in Examples 1 to 5, even when the driving frequency was high, an excellent frequency characteristic was obtained without causing non-discharge of the ink. It is understood from Examples 1 to 5 that owing to the matter that the yellow ink using C.I. Pigment Yellow 128 contains a suitable amount of the sulfonated isoprene resin in addition to the water-soluble resin as a dispersant, a yellow ink with excellent discharge stability is obtained without generating unevenness in printing or a blur.

It should be understood by those skilled in the art that various modifications, combinations, sub-combinations and alternations may occur depending on design requirements and other factors insofar as they are within the scope of the appended claims or the equivalents thereof.

What is claimed is:

1. A recording liquid comprising
C.I. Pigment Yellow 128 as a yellow pigment;
a water-soluble resin containing at least a (meth)-acrylic acid monomer component as a dispersant; and
a sulfonated isoprene resin.

2. The recording liquid according to claim 1, wherein
the sulfonated isoprene resin is contained in an amount of from 0.1% by weight to 6.0% by weight in terms of solids relative to the total weight.

3. A recording method comprising the steps of:
pressurizing a recording liquid by a pressure-generating element; and
discharging the pressurized recording liquid from a discharge opening to impact the recording liquid on a medium to be recorded,
the recording liquid containing C.I. Pigment Yellow 128 as a yellow pigment, a water-soluble resin containing at least a (meth)acrylic acid monomer component as a dispersant and a sulfonated isoprene resin.

4. The recording method according to claim 3, wherein
the recording liquid contains the sulfonated isoprene resin in an amount of from 0.1% by weight to 6.0% by weight in terms of solids relative to the total weight.

5. The recording method according to claim 3, wherein
the pressure-generating element is a heat-generating resistor.
